(19) United States
(12) Patent Application Publication
(10) Pub. No.: US 2008/0010362 A1
(43) Pub. Date: Jan. 10, 2008

(54) COMMUNICATION TERMINAL, SYSTEM AND METHOD FOR IMPLEMENTING STREAMING SERVICE

(76) Inventor: Yunhong ZHOU, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/769,980

(22) Filed: Jun. 28, 2007

Related U.S. Application Data
(63) Continuation of application No. PCT/CN05/02365, filed on Dec. 29, 2005.

(30) Foreign Application Priority Data
Dec. 29, 2004 (CN) 200410102677.2

(51) Int. Cl. G06F 15/16

(52) U.S. Cl. 709/219

(57) ABSTRACT

A communication terminal for implementing a streaming service disclosed by embodiments of the present invention includes: a call control unit, an audio processing unit, a video processing unit and a communication processing unit; the communication terminal further includes: a streaming control unit which respectively exchanges the communication signaling with the call control unit, the audio processing unit, the video processing unit and the communication processing unit and is used for processing the protocol associated with the streaming playing and control, and controlling the procedure of a streaming service. Embodiments of the present invention further disclose a system and a method for implementing a streaming service. The communication terminal has the IP Digital Set Top Box (DSTB) function, which implements not only the video/audio communication, but also a streaming service. The system and method disclosed may implement a communication terminal based streaming service.

### FIELD OF THE INVENTION

The present invention relates to the wideband video technology, and more particularly, to a communication terminal, a system and a method for implementing a streaming service in a wideband video system.

### BACKGROUND OF THE INVENTION

Along with the rapid development of wideband technology, various wideband based applications emerge, and wideband based video/audio applications are even rapidly developed and widely applied. On one hand, in a wideband network, two standard videoconferencing communication architectures based on the ITU-T H.323 protocol and the Session Initial Protocol (SIP) are developed, while some videoconferencing communication architectures based on the customized private protocols also exist. In a videoconferencing communication system, through adopting terminals with the videoconferencing function, voice and video data interaction between two parties or among multiple parties can be realized. On the other hand, in a wideband network, there occurs an Internet Protocol (IP) Digital Set Top Box (DSTB) device based on the streaming technology which has the function of surfing, live and on-demand movie or TV program.

FIG. 1 is a schematic diagram illustrating a structure of a communication terminal with the videoconferencing function in prior art. As shown in FIG. 1, a communication terminal with the videoconferencing function includes a call control unit, a video processing unit, an audio processing unit and a communication processing unit. The communication processing unit is mainly used for connecting with the communication network, receiving data from the communication network, and sending data to the communication network; the video processing unit is mainly used for the collection, CODEC processing and display of a video image; the audio processing unit is mainly used for the collection, CODEC processing and playing of voice data; the call control unit is responsible for the protocol processing associated with call, controlling a procedure associated with call, and establishing a video/audio conversation with other communication terminals.

As aforementioned, in prior art, a communication terminal and an IP DSTB at the user side are two independent devices; wherein the IP DSTB, without a video/audio communication function, is mainly used for surfing as well as watching movies and TV programs; the communication terminal may implement the video/audio communication without the function for implementing such streaming services as surfing, watching movies and TV programs.

### SUMMARY OF THE INVENTION

Embodiments of the present invention provide a communication terminal for implementing a streaming service.

Embodiments of the present invention also provide a system and a method for implementing a streaming service, which implement a streaming service by means of the communication terminal with a streaming function.

A communication terminal for implementing a streaming service includes: a call control unit, an audio processing unit, a video processing unit and a communication processing unit;

wherein the communication terminal further comprises a streaming control unit for processing protocols associated with streaming playing and control and controlling the related procedure of a streaming service;

the call control unit is configured for initiating a request for streaming service related information to a network side via the communication processing unit, and forwarding the streaming service related information returned by the network side via the communication processing unit to the streaming control unit, or

the streaming control unit is configured for initiating the request for streaming service related information to the network side via the communication processing unit, and receiving the streaming service related information returned by the network side via the communication processing unit;

the streaming control unit is configured for requesting the network side for playing streaming data according to the streaming service related information, and instructing the audio processing unit and the video processing unit to play the streaming data returned by the network side after the requesting is successful.

A system for implementing a streaming service includes:

a communication terminal, configured to initiate a request for streaming service related information and receive the streaming service related information requested, and initiate a request for playing streaming data;

a registration server for implementing registration, authentication and called number resolution for the communication terminal, configured to provide the communication terminal with the streaming service related information after receiving the request for the streaming service related information;

a streaming server, configured to provide the communication terminal with the streaming data after receiving the request for playing streaming data.

A system for implementing a streaming service includes:

a communication terminal, configured to initiate a request for streaming service related information and receive the streaming service related information, and initiate a request for playing streaming data;

a streaming service server, configured to provide the communication terminal with the streaming service related information after receiving the request for the streaming service related information;

a streaming server, configured to provide the communication terminal with the streaming data after receiving the request for playing the streaming data.

A method for a communication terminal implementing a streaming service includes:

initiating a request to a network side for streaming service related information;

receiving an acknowledge message containing the streaming service related information from the network side if the communication terminal is authenticated;

requesting the network side for playing streaming data according to the streaming service related information.

A method for a communication terminal implementing a streaming service includes:

initiating a streaming service searching request to a network side after the communication terminal is registered;

receiving a streaming service searching response containing streaming service related information from the network side;

requesting the network side for playing streaming data according to the streaming service related information.

As can be seen from the above technical solution, the communication terminal disclosed by embodiments of the present invention includes not only the call control unit, the audio processing unit, the video processing unit and the communication processing unit possessed by the existing communication terminal, but also a streaming control unit which respectively exchanges the communication signaling with the call control unit, the audio processing unit, the video processing unit and the communication processing unit and is used for processing the protocol associated with the playing and control of streaming, and controlling the procedure of streaming service. Therefore, the communication terminal of the present invention implements not only the video/audio communication function, but also the IP Digital Set Top Box (DSTB) function of implementing a streaming service.

The system and method disclosed by the present invention for implementing a streaming service can implement a communication terminal based streaming service, obtain the streaming service related information by the registration procedure or call procedure of communication terminal, or by individual streaming service searching request procedure, and request for streaming data according to the streaming service related information, so as to implement a streaming service.

### BRIEF DESCRIPTION OF THE DRAWINGS

FIG. 1 is a schematic diagram illustrating a structure of a communication terminal for implementing video/audio communication in prior art.

FIG. 2 is a schematic diagram illustrating a structure of a communication terminal with the streaming function in accordance with the embodiments of the present invention;

FIG. 3a is a schematic diagram of implementing a streaming service in accordance with a first embodiment of the present invention.

FIG. 3b is a schematic diagram illustrating communication signaling interaction of the first embodiment as shown in FIG. 3a.

FIG. 3c is a schematic diagram illustrating streaming data transmission of the first embodiment as shown in FIG. 3a.

FIG. 4a is a schematic diagram of implementing a streaming service in accordance with a second embodiment of the present invention.

FIG. 4b is a schematic diagram illustrating communication signaling interaction of the second embodiment as shown in FIG. 4a.

FIG. 5a is a schematic diagram of implementing a streaming service in accordance with a third embodiment of the present invention.

FIG. 5b is a schematic diagram illustrating communication signaling interaction of the third embodiment as shown in FIG. 5a.

FIG. 6a is a schematic diagram of implementing a streaming service in accordance with a fourth embodiment of the present invention.

FIG. 6b is a schematic diagram illustrating communication signaling interaction of the fourth embodiment as shown in FIG. 6a.

### DETAILED DESCRIPTION OF THE INVENTION

In order to make the solution and merits of the present invention clearer, a detailed description of the present invention is hereinafter given with reference to specific embodiments and the accompanying drawings.

According to embodiments of the present invention, a streaming control unit for processing protocols associated with the streaming playing and control is added in a communication terminal, and communication signaling used by the communication terminal is extended accordingly to support a streaming service, so that a streaming service is implemented in the communication terminal.

According to the embodiments of the present invention, a convenient communication terminal based streaming service is provided for users without changing usage habit of the users through integrating IP Set Top Box (STB) function into the communication terminal. Therefore, the uniform function combining the IP STB with the communication terminal is implemented; and as a result, a user is able to use the communication terminal with a streaming function conveniently and flexibly in the premise of increasing a little cost.

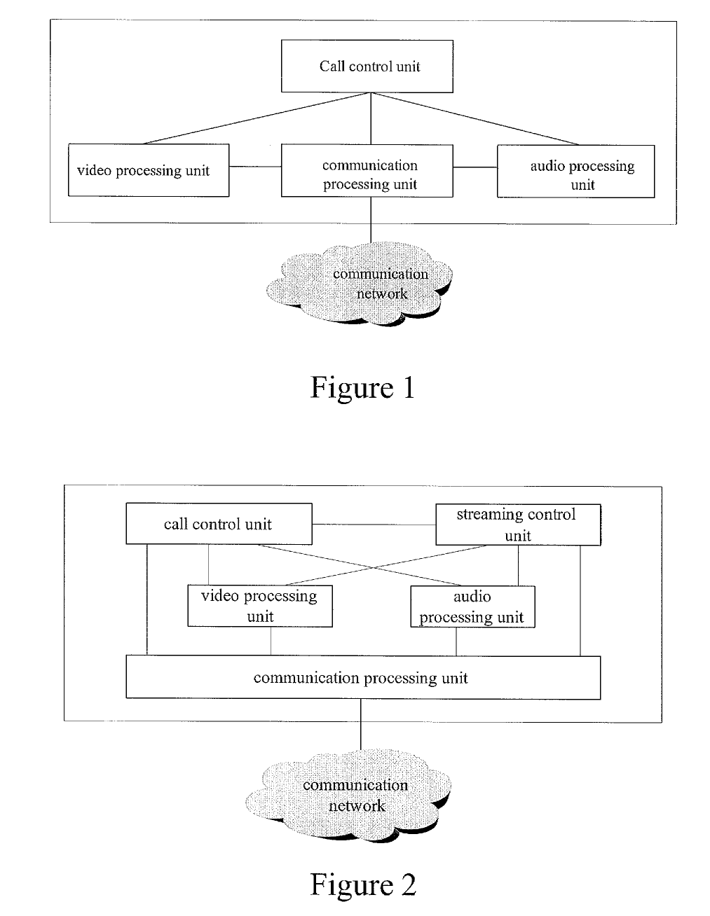

FIG. 2 is a schematic diagram illustrating a structure of a communication terminal with the streaming function in accordance with the embodiments of present invention. Referring to FIG. 2, the communication terminal of the embodiments mainly includes a streaming control unit, a call control unit, a video processing unit, an audio processing unit and a communication processing unit.

The call control unit, the video processing unit, the audio processing unit and the communication processing unit have the basic function of the corresponding unit in the existing communication terminal respectively. The video/audio communication function of the existing communication terminal may be implemented by the cooperation of these units.

The streaming control unit may process the protocol associated with the streaming playing and control, control the related procedure of a streaming service, respectively connect with the call control unit, the video processing unit, the audio processing unit and the communication processing unit, and implement the streaming function which is not possessed by the existing communication terminal through cooperating with the other units.

The communication terminal performs the interaction with a registration server in the network side to complete the registration procedure of communication terminal during video/audio communication. In the process for calling another communication terminal, the communication terminal may also implement call authentication and address resolution function by interacting with the registration server in the network side, and establish the connection and call with the another communication terminal.

The communication signaling interacted between the communication terminal and the registration server in the network side is extended to support the transmission of streaming related information. Therefore the streaming service is supported by the communication terminal. A new streaming service dedicated communication signaling may be introduced to the interaction between the communication terminal and the network side, so that the streaming service is supported by the communication terminal.

As can be seen that, in comparison with the existing communication terminal, the communication terminal of the embodiments may implement a streaming service while implementing the video/audio communication since the streaming control unit is added and the original communication signaling is extended or a new streaming service communication signaling is added.

The communication terminal, system and method for implementing a streaming service in accordance with embodiments of the present invention are hereinafter described in detail with respect to four preferred embodiments for implementing a streaming service.

### First Embodiment

In this embodiment, a communication terminal obtains the streaming service related information in a registration procedure. In this way, such services as the on-demand service and the live streaming service will be provided to a user of the communication terminal via a programming list, or a streaming advertisement is automatically played to the user of the communication terminal when the communication terminal is idle.

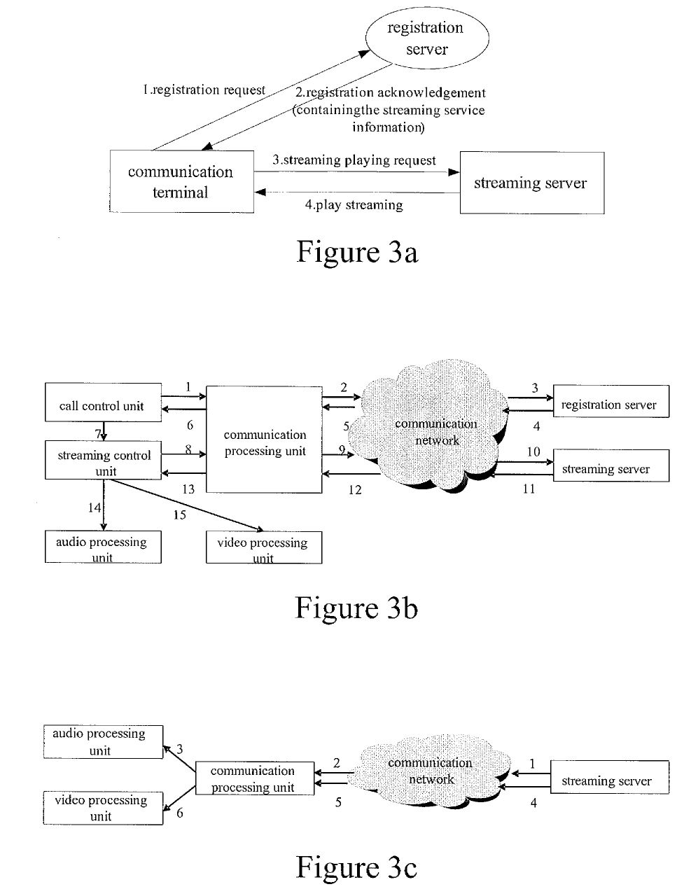

FIG. 3a is a schematic diagram of implementing streaming service in accordance with the first embodiment of the present invention. Referring to FIG. 3a, in the first embodiment, the system for implementing a streaming service includes a communication terminal with the streaming function, a registration server in a network side and a streaming server in the network side.

The registration server in the network side is mainly used for implementing the registration, authentication and called number resolution function for the communication terminal. The streaming service related information such as the streaming programming list information and the streaming advertisement information is stored in the registration server. The streaming programming list information includes names of multiple streaming programs and Uniform Resource Locator (URL) links of the streaming programs; the streaming advertisement information includes names of the streaming advertisements and URL links of the streaming advertisements. The streaming programming list information may also only include single streaming program information, i.e. the URL link of single streaming program.

Streaming data as streaming programs and streaming advertisements is stored in the streaming server in the network side mainly used for implementing the streaming on-demand and live service functions.

Referring to FIG. 3a, in the first embodiment, the method for implementing a streaming service specifically includes the following steps.

First, the communication terminal sends a registration request to the registration server.

Second, the registration service authenticates the communication terminal, returns a successful registration acknowledgement message containing the streaming service related information to the communication terminal after the communication terminal is authenticated. The streaming service related information is the streaming programming list information and the streaming advertisement information, etc.

Third, after receiving the successful registration acknowledgement message returned by the registration server, the communication terminal extracts the streaming programming list information or the streaming advertisement information. If the streaming programming list information is extracted, the communication terminal displays the streaming programming list to the user, and requests the streaming server for playing the streaming program selected by the user after receiving the program selected by the user; if the streaming advertisement information is extracted, the communication terminal requests the streaming server for playing a designated streaming advertisement in idle state, i.e., when the communication terminal does not use a service and does not perform any operation.

Fourth, the streaming server plays the streaming program or advertisement for the communication terminal, i.e., returns the streaming data corresponding to the streaming program or advertisement requested by the communication terminal to the communication terminal.

FIG. 3b is a schematic diagram illustrating the communication signaling interaction of the first embodiment. Referring to FIG. 3b, the call control unit sends a registration request to the registration server via the communication processing unit and the communication network; the registration server returns a successful registration acknowledgement message to the communication processing unit via the communication network after the communication terminal is authenticated; the communication processing unit forwards the successful registration acknowledgement message to the call control unit for processing; the call control unit extracts the streaming service related information from the successful registration acknowledgement message and forwards the streaming service related information to the streaming control unit; if the streaming service related information includes the streaming programming list information, the streaming control unit displays the streaming programming list for the user and receives the selection of the user; the streaming control unit initiates a connection request for the streaming program or streaming advertisement selected by the user to the streaming server via the communication processing unit and the communication network; the streaming server returns the connection request result to the communication processing unit via the communication network; the communication process unit forwards the connection request result to the streaming control unit for processing; the streaming control unit instructs the audio processing unit and the video processing unit to receive and play the streaming data after the connection is successful.

FIG. 3c is a schematic diagram of playing streaming data in accordance with the first embodiment. Referring to FIG. 3c, the streaming server sends an audio media stream and a video media stream to the communication processing unit via the communication network; the communication processing unit forwards the received audio media stream to the audio processing unit for decoding and playing, and forwards the received video media stream to the video processing unit for decoding and playing.

In this way, a communication service and a streaming service are combined, which provides the user of the communication terminal with the streaming on-demand and live function conveniently based on the communication service procedure, and provides the service operator with the possibility of value-added service such as a streaming advertisement.

### Second Embodiment

In this embodiment, the communication terminal initiates a streaming on-demand and live service by the normal call method, and provides a user of the communication terminal with the streaming service function like an automatic station.

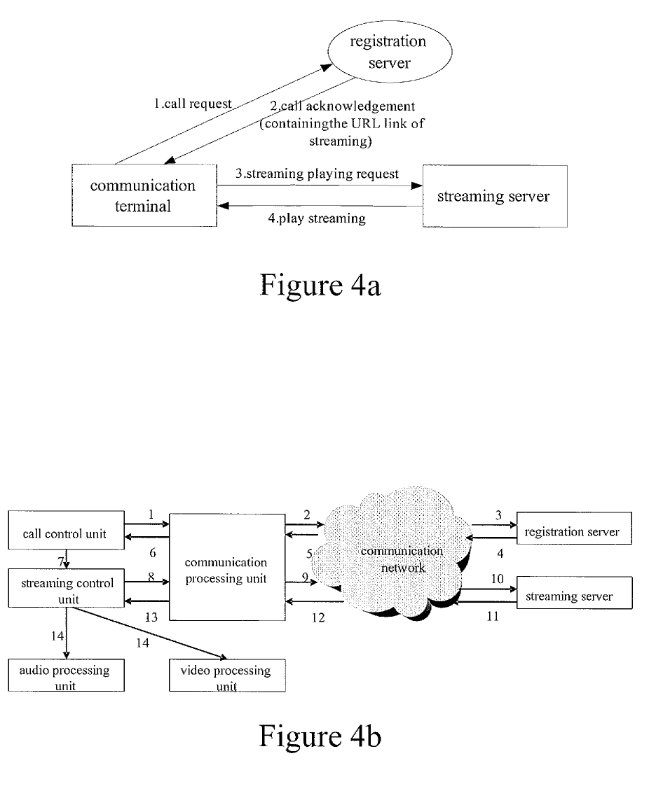

FIG. 4a is a schematic diagram of implementing a streaming service in accordance with the second embodiment of the present invention. Referring to FIG. 4a, in the second embodiment, the system for implementing a streaming service includes a communication terminal with the streaming function, a registration server in the network side and a streaming server in the network side.

The registration server in the network side stores not only the streaming service related information described in the first embodiment, but also the correspondence relationship between streaming service number and the streaming service related information. The registration server searches and returns the streaming service related information corresponding to the streaming service number after receiving the streaming service number.

Referring to FIG. 4a, in the second embodiment, the method for implementing a streaming service specifically includes the following steps.

First, the communication terminal sends to the registration server a call request, the called number is a streaming service number.

Second, the registration server authenticates the communication terminal, extracts the called number after the communication terminal is authenticated; if the extracted number is a streaming service number, searches for the streaming service related-information corresponding to the streaming service number according to the saved correspondence relationship between streaming service number and the streaming service related information, and returns a call acknowledgement message containing the streaming service related information corresponding to the streaming service number back to the communication terminal. In this embodiment, the streaming service related information generally includes only the URL link of single streaming program.

Third, if the call acknowledgement message includes the streaming service related information which is the URL link of single streaming program, the communication terminal requests for playing streaming data indicated by the URL link of the streaming program after receiving the call acknowledgement message.

Fourth, the streaming server plays a streaming program for the communication terminal, i.e. returns the streaming data corresponding to the streaming program requested by the communication terminal to the communication terminal.

FIG. 4b is a schematic diagram illustrating the communication signaling interaction of the second embodiment Referring to FIG. 4b, the call control unit sends a call request to the registration server in the network side via the communication processing unit and the communication network; the registration server extracts the called number, and returns a call acknowledgement message containing the streaming service related information corresponding to the called number to the communication processing unit after the communication terminal is authenticated; the communication processing unit forwards the call acknowledgement message to the call control unit; the call control unit extracts the streaming service related information such as the URL link of single streaming program and forwards the streaming service related information to the streaming control unit; the streaming control unit initiates a connection request for the single streaming program to the streaming server via the communication processing unit; the streaming server returns the connection request result to the communication processing unit via the communication network; the communication process unit forwards the connection request result to the streaming control unit for processing; the streaming control unit instructs the audio processing unit and the video processing unit to receive and play the data after the connection is successful.

The playing of streaming data of this embodiment is the same as that of the first embodiment as shown in FIG. 3c, which will not be described in detail herein.

In this way, such services as the streaming on-demand and live service may be implemented by the conventional method for dialing a phone number, which will be accepted and used by the user of the common communication terminal easily and makes it possible for a service operator to provide various value-added services according to such a simple and convenient method.

### Third Embodiment

In this embodiment, the communication terminal initiates an individual streaming service searching request after the registration procedure is finished. As a result, it is needless to extend the existing registration procedure.

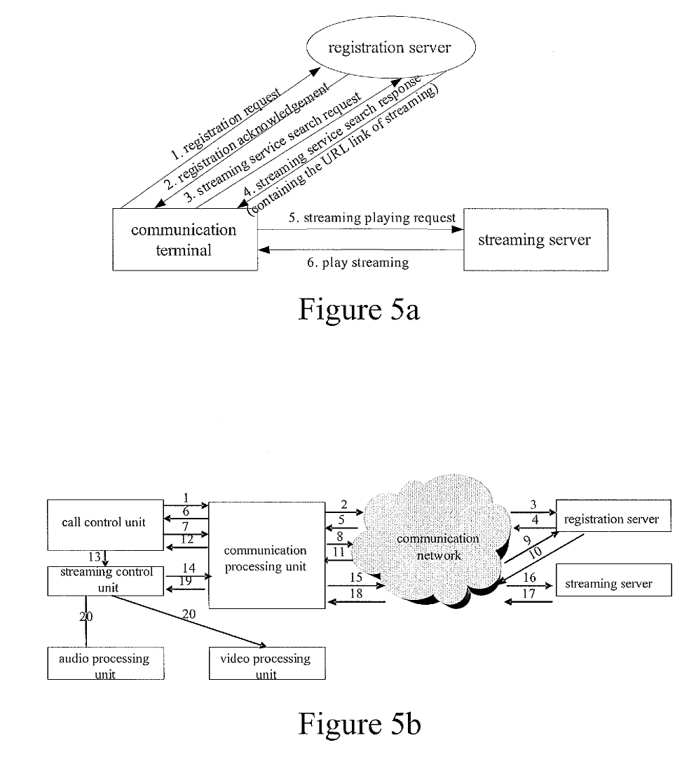

FIG. 5a is a schematic diagram of implementing a streaming service in accordance with a third embodiment of the present invention. Referring to FIG. 5a, in the third embodiment, the system for implementing a streaming service includes a communication terminal with the streaming function, a registration server in a network side and a streaming server in the network side.

The function of the registration server and the streaming server is the same as that of the first embodiment.

Referring to FIG. 5a, in the third embodiment, the method for implementing a streaming service specifically includes the following steps.

First, the communication terminal sends a registration request to the registration server.

Second, the registration server authenticates the communication terminal, returns a successful registration acknowledgement message containing no streaming service related information to the communication terminal after the communication terminal is authenticated.

Third, the communication terminal sends a streaming service searching request to the registration server.

Fourth, after receiving the streaming service searching request, the registration server returns a streaming service searching response containing the streaming service related information to the communication terminal.

Fifth, the communication terminal requests the streaming server for playing streaming data according to the streaming service related information. The detailed implementation method of this embodiment is the same as the third step and the fourth step of the first embodiment, which will not be further described herein.

FIG. 5b is a schematic diagram illustrating the communication signaling interaction of the third embodiment. Referring to FIG. 5b, the call control unit sends a registration request to the registration server via the communication processing unit and the communication network; the registration server returns a successful registration acknowledgement message to the communication processing unit via the communication network after the communication terminal is authenticated; the communication processing unit forwards the successful registration acknowledgement message to the call control unit; the call control unit sends a streaming service searching request to the registration server via the communication processing unit and the communication network; the registration server returns to the communication processing unit a streaming service searching response containing the streaming service related information via the communication network; the communication processing unit forwards the streaming service searching response to the call control unit; the call control unit extracts the streaming service related information from the streaming service searching response and forwards it to the streaming control unit; if the streaming service related information includes the streaming programming list information, the streaming control unit displays the streaming programming list for the user and receives the selection of the user; the streaming control unit initiates a connection request for the streaming program or streaming advertisement selected by the user to the streaming server via the communication processing unit and the communication network; the streaming server returns the connection request result to the communication processing unit via the communication network; the communication process unit forwards the connection request result to the streaming control unit for processing; the streaming control unit instructs the audio processing unit and the video processing unit to receive and play the data after the connection is successful.

The playing of streaming data of this embodiment is the same as that of the first embodiment as shown in FIG. 3c, which will no be described in detail herein.

In this way, since a dedicated streaming search request and response signaling are introduced, it is needless to extend the existing standard signaling of registration procedure.

### Fourth Embodiment

The difference of this embodiment from the third embodiment is that, the registration server is not responsible for streaming service searching, and a dedicated streaming service server having the streaming service searching function is used; the communication terminal requests to search a streaming service from the streaming service server instead of the registration server.

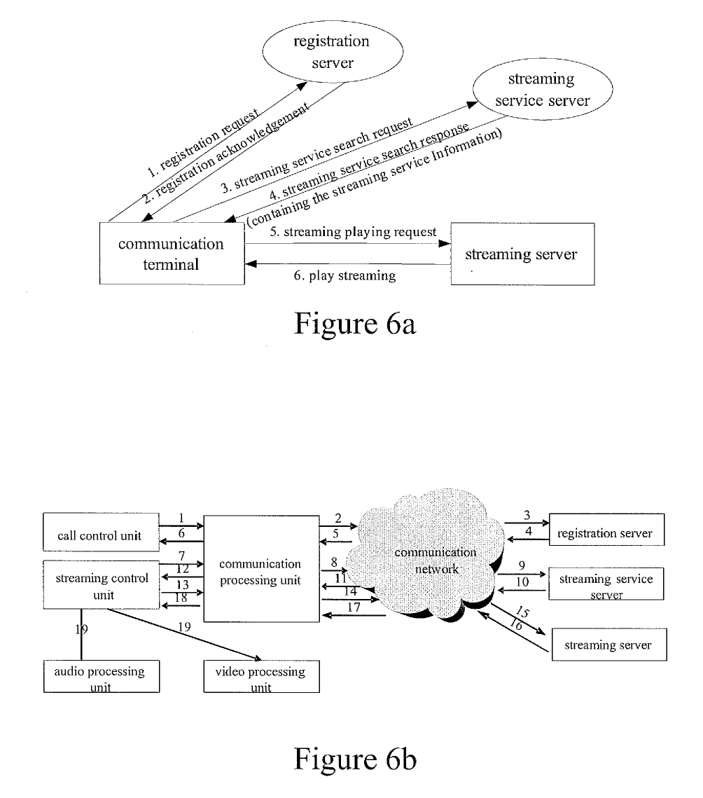

FIG. 6a is a schematic diagram of a streaming service procedure in accordance with a fourth embodiment of the present invention. Referring to FIG. 6a, in the fourth embodiment, the system for implementing a streaming service includes a communication terminal with the streaming function, a registration server in the network side, a streaming server in the network side and a streaming service server in the network side.

The difference of this embodiment from the third embodiment is that, the registration server does not save the streaming service related information; the streaming service server saves the streaming service related information, and provides the communication terminal with the streaming service searching function.

Referring to FIG. 6a, in the fourth embodiment, the method for implementing a streaming service specifically includes the following steps.

First, the communication terminal sends a registration request to the registration server.

Second, the registration server authenticates the communication terminal, returns a successful registration acknowledgement message containing no streaming service related information to the communication terminal after the communication terminal is authenticated.

Third, the communication terminal sends a streaming service searching request to the streaming service server.

Fourth, after receiving the streaming service searching request, the streaming service server returns the streaming service related information to the communication terminal.

Fifth, the communication terminal requests the streaming server for playing streaming data according to the received streaming service related information. The detailed implementation method of this embodiment is the same as the third step and the fourth step of the first embodiment, which will not be further described herein.

FIG. 6b is a schematic diagram illustrating the communication signaling interaction of the fourth embodiment. Referring to FIG. 6b, the call control unit sends a registration request to the registration server via the communication processing unit and the communication network; the registration server returns a successful registration acknowledgement message to the communication processing unit via the communication network after the communication terminal is authenticated; the communication processing unit forwards the successful registration acknowledgement message to the call control unit for processing; the streaming control unit sends a streaming service searching request to the streaming service server over the communication processing unit and the communication network; the streaming service server returns to the communication processing unit a streaming service searching response containing the streaming service related information via the communication network; the communication processing unit forwards the streaming service searching response to the call control unit; the call control unit extracts the streaming service related information from the streaming service searching response and forwards the streaming service related information to the streaming control unit; if the streaming service related information includes the streaming programming list information, the streaming control unit displays the streaming programming list for the user and receives the selection of the user; the streaming control unit initiates a connection request for the streaming program or streaming advertisement selected by the user to the streaming server via the communication processing unit and the communication network; the streaming server returns the connection request result to the communication processing unit via the communication network; the communication process unit forwards the connection request result to the streaming control unit for processing; the streaming control unit instructs the audio processing unit and the video processing unit to receive and play the data after the connection is successful.

The playing of streaming data of this embodiment is the same as that of the first embodiment as shown in FIG. 3c, which will no be described in detail herein.

The preferred embodiments of the present invention can be modified appropriately during specific implementation to meet the detailed requirements of specific cases. It is thereby understood that the specific embodiments described in this disclosure are demonstrative rather than limiting the protection scope of the present invention.

1. A communication terminal for implementing a streaming service, comprising: a call control unit, an audio processing unit, a video processing unit and a communication processing unit;
wherein the communication terminal further comprises a streaming control unit for processing protocols associated with streaming playing and control and controlling the related procedure of a streaming service;
the call control unit is configured for initiating a request for streaming service related information to a network side via the communication processing unit, and forwarding the streaming service related information returned by the network side via the communication processing unit to the streaming control unit, or
the streaming control unit is configured for initiating the request for streaming service related information to the network side via the communication processing unit, and receiving the streaming service related information returned by the network side via the communication processing unit;
the streaming control unit is configured for requesting the network side for playing streaming data according to the streaming service related information, and instructing the audio processing unit and the video processing unit to play the streaming data returned by the network side after the requesting is successful.

2. The communication terminal of claim 1, wherein the call control unit, the audio processing unit, the video processing unit and the communication processing unit connect to each other to implement video/audio communication.

3. The communication terminal of claim 1, wherein an interactive communication signaling between the streaming control unit and the call control unit, the audio processing unit, the video processing unit or the communication processing unit comprises an extended communication signaling supporting the streaming service related information transmission.

4. A system for implementing a streaming service, comprising:
a communication terminal, configured to initiate a request for streaming service related information and receive the streaming service related information requested, and initiate a request for playing streaming data;
a registration server for implementing registration, authentication and called number resolution for the communication terminal, configured to provide the communication terminal with the streaming service related information after receiving the request for the streaming service related information;
a streaming server, configured to provide the communication terminal with the streaming data after receiving the request for playing streaming data.

5. The system of claim 4, wherein the request for streaming service related information comprises: a registration request, a call request or a streaming service searching request.

6. A system for implementing a streaming service, comprising:
a communication terminal, configured to initiate a request for streaming service related information and receive the streaming service related information, and initiate a request for playing streaming data;
a streaming service server, configured to provide the communication terminal with the streaming service related information after receiving the request for the streaming service related information;
a streaming server, configured to provide the communication terminal with the streaming data after receiving the request for playing the streaming data.

7. The system of claim 6, further comprising:
a registration server for implementing registration, authentication and called number resolution function for the communication terminal.

8. The system of claim 6, wherein the request for streaming service related information comprises a streaming service searching request.

9. A method for a communication terminal implementing a streaming service, comprising:
initiating a request to a network side for streaming service related information;
receiving an acknowledge message containing the streaming service related information from the network side if the communication terminal is authenticated;
requesting the network side for playing streaming data according to the streaming service related information.

10. The method of claim 9, wherein the request for the streaming service related information is a registration request;
the acknowledge message containing the streaming service related information is a registration acknowledge message containing the streaming service related information.

11. The method of claim 9, wherein the request for the streaming service related information is a call request whose a called number is a streaming service number;
the method further comprises: after the communication is authenticated, extracting, by the network side, the streaming service number, obtaining the streaming service related information corresponding to the streaming service number according to a relationship between streaming service numbers and the streaming service related information;
the acknowledge message containing the streaming service related information is a call acknowledge message containing the streaming service related information.

12. The method of claim 10, wherein the streaming service related information comprises at least one of streaming programming list information and streaming advertisement information.

13. The method of claim 12, wherein the streaming programming list information comprises as least one name of a streaming program and a Uniform Resource Locator (URL) link of the streaming program; the streaming advertisement information comprises a URL link of streaming advertisement.

14. The method of claim 12, further comprising:
if the streaming service related information is the streaming programming list information, displaying a streaming programming list, requesting the network side for the streaming data corresponding to a streaming program selected by a user, and playing the streaming data returned by the network side.

15. The method of claim 12, further comprising:
if the streaming service related information is the streaming advertisement information, requesting the network side for the streaming data corresponding to the streaming advertisement information in idle time, and playing the streaming data returned by the network side.

16. The method of claim 9, wherein a registration server of the network side authenticates the communication terminal and returns an acknowledge message to the communication terminal is the communication terminal is passed;
the communication terminal requests a streaming server in the network side for playing streaming data.

17. A method for a communication terminal implementing a streaming service, comprising:
initiating a streaming service searching request to a network side after the communication terminal is registered;
receiving a streaming service searching response containing streaming service related information from the network side;
requesting the network side for playing streaming data according to the streaming service related information.

18. The method of claim 17, wherein the streaming service related information comprises at least one of streaming programming list information and the streaming advertisement information.

19. The method of claim 18, wherein the streaming programming list information comprises as least one name of a streaming program and a Uniform Resource Locator (URL) link of the streaming program; the streaming advertisement information comprises a URL link of streaming advertisement.

20. The method of claim 18, further comprising:
if the streaming service related information is the streaming programming list information, displaying the streaming programming list, requesting the network side for the streaming data corresponding to a streaming program selected by a user, and playing the streaming data returned by the network side.

21. The method of claim 18, further comprising:
if the streaming service related information is the streaming advertisement information, requesting the network side for the streaming data corresponding to the streaming advertisement information in idle time, and playing the streaming data returned by the network side.

22. The method of claim 17, wherein the communication terminal initiates the streaming service searching request to a streaming service server in the network side, and receives the streaming service searching response returned by the streaming service server;
the communication terminal requests a streaming server in the network side for playing streaming data.
